(19) United States
(12) Patent Application Publication
(10) Pub. No.: US 2021/0227307 A1
(43) Pub. Date: Jul. 22, 2021

(54) SUPPORT BASE AND DISPLAY DEVICE

(71) Applicant: QISDA CORPORATION, Taoyuan City (TW)

(72) Inventors: Shin-Hao Wu, Taoyuan City (TW); Hsin-Hung Lin, Taoyuan City (TW); Han-Kuang Ho, Taoyuan City (TW)

(21) Appl. No.: 16/831,766

(22) Filed: Mar. 26, 2020

(30) Foreign Application Priority Data
Jan. 17, 2020 (TW) 109101616

(51) Int. Cl. H04R 1/02; F16M 11/22; H04R 1/28

(52) U.S. Cl. CPC H04R 1/025; F16M 11/10; H04R 1/2803; F16M 11/22

(57) ABSTRACT

A support base includes a base body, a support frame, at least one nonlinear sound passage and a speaker. The support frame is disposed on the base body. At least one of the base body and the support frame has an accommodating structure. The at least one nonlinear sound passage is selectively disposed in at least one of the base body and the support frame. The speaker is accommodated by the accommodating structure. The speaker outputs sound to the nonlinear sound passage.

### BACKGROUND OF THE INVENTION

### 1. Field of the Invention

The invention relates to a support base and a display device and, more particularly, to a support base capable of enhancing sound effect for a speaker effectively and a display device equipped with the support base.

### 2. Description of the Prior Art

Currently, lots of display devices are equipped with a speaker for outputting sound effect. The speaker of a conventional display device is disposed in a casing. Since the space inside the casing is limited, the volume of the speaker cannot be too large, such that the display device must be equipped with two speakers for outputting desired sound effect. However, two speakers occupy a specific amount of space, such that the display device cannot be thinned. Furthermore, the casing of the conventional display device does not have a sound box for accommodating the speaker. Therefore, the sound effect of the speaker cannot be enhanced.

### SUMMARY OF THE INVENTION

An objective of the invention is to provide a support base capable of enhancing sound effect for a speaker effectively and a display device equipped with the support base, so as to solve the aforesaid problems.

According to an embodiment of the invention, a support base comprises a base body, a support frame, at least one nonlinear sound passage and a speaker. The support frame is disposed on the base body. At least one of the base body and the support frame has an accommodating structure. The at least one nonlinear sound passage is selectively disposed in at least one of the base body and the support frame. The speaker is accommodated by the accommodating structure. The speaker outputs sound to the nonlinear sound passage.

According to another embodiment of the invention, a display device comprises a support base and a display unit. The support base comprises a base body, a support frame, at least one nonlinear sound passage and a speaker. The support frame is disposed on the base body. At least one of the base body and the support frame has an accommodating structure. The at least one nonlinear sound passage is selectively disposed in at least one of the base body and the support frame. The speaker is accommodated by the accommodating structure. The speaker outputs sound to the nonlinear sound passage. The display unit is disposed on the support frame.

As mentioned in the above, the invention disposes the speaker in the support base. Since a casing of the display device does not need to retain a space for accommodating the speaker, the display device can be further thinned. Furthermore, the invention further disposes the nonlinear sound passage in at least one of the base body and the support frame of the support base. When the sound outputted by the speaker passes through the nonlinear sound passage, the nonlinear sound passage continuously reflects the sound to reinforce the amplitude of the sound. Accordingly, the invention can enhance sound effect for the speaker effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a display device according to an embodiment of the invention.

FIG. 2 is an exploded view illustrating the support base shown in FIG. 1 from another viewing angle.

FIG. 3 is an exploded view illustrating the support base shown in FIG. 1 from another viewing angle.

FIG. 4 is a bottom view illustrating the base body shown in FIG. 3.

FIG. 5 is a sectional view illustrating the support base shown in FIG. 1.

FIG. 6 is a perspective view illustrating a support base according to another embodiment of the invention.

FIG. 7 is an exploded view illustrating the support base shown in FIG. 6.

FIG. 8 is a front view illustrating the support frame and the speaker shown in FIG. 7.

### DETAILED DESCRIPTION

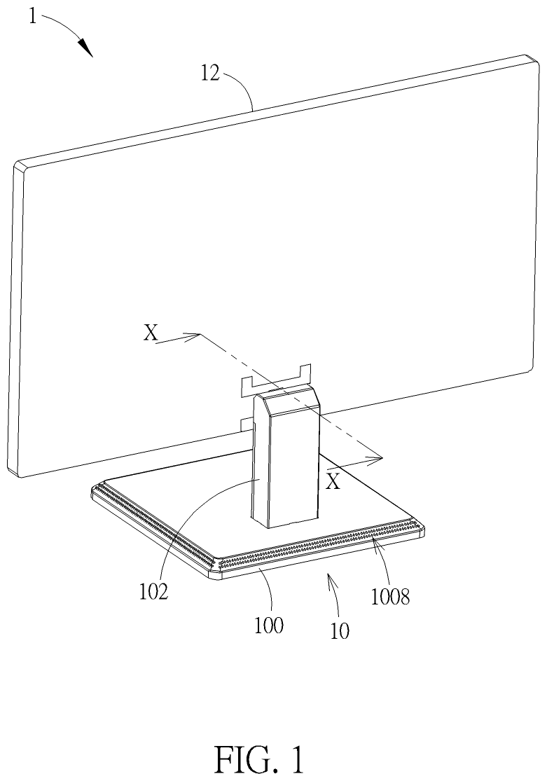

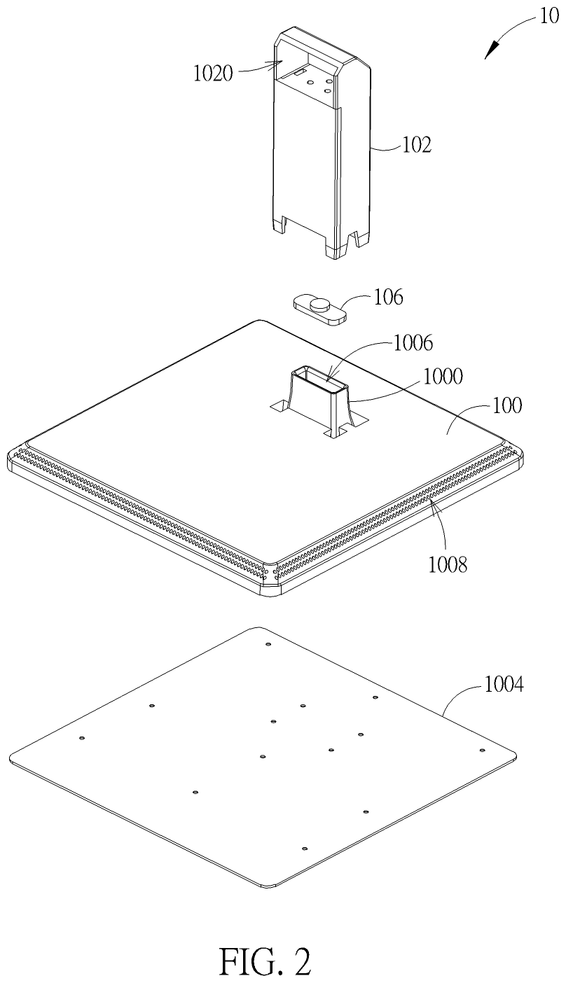

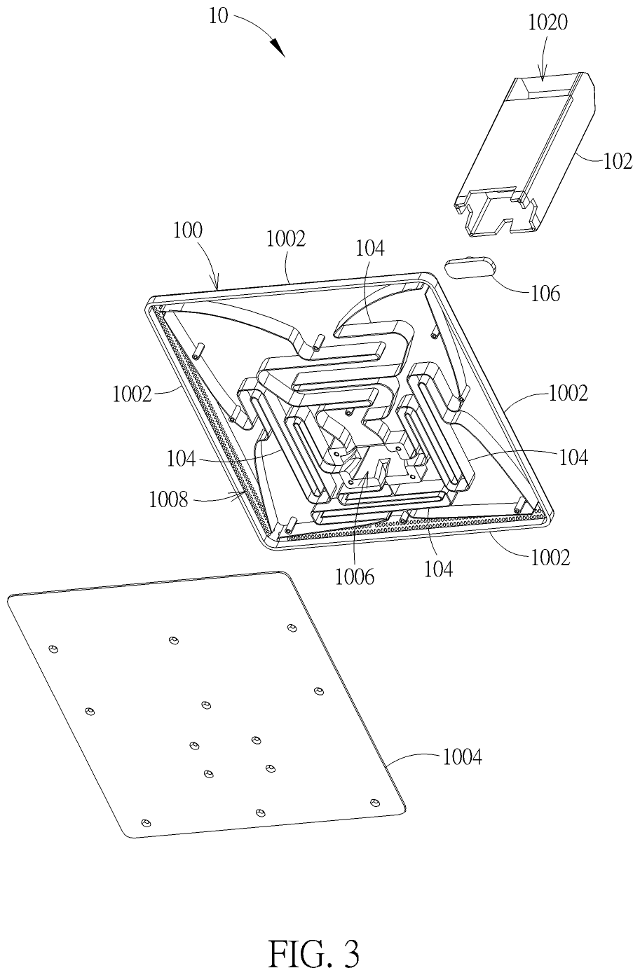

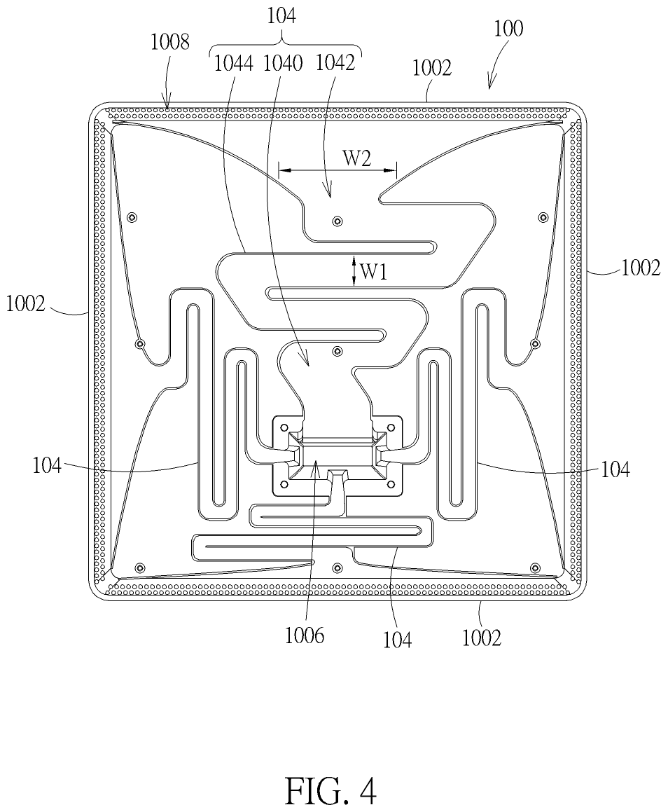

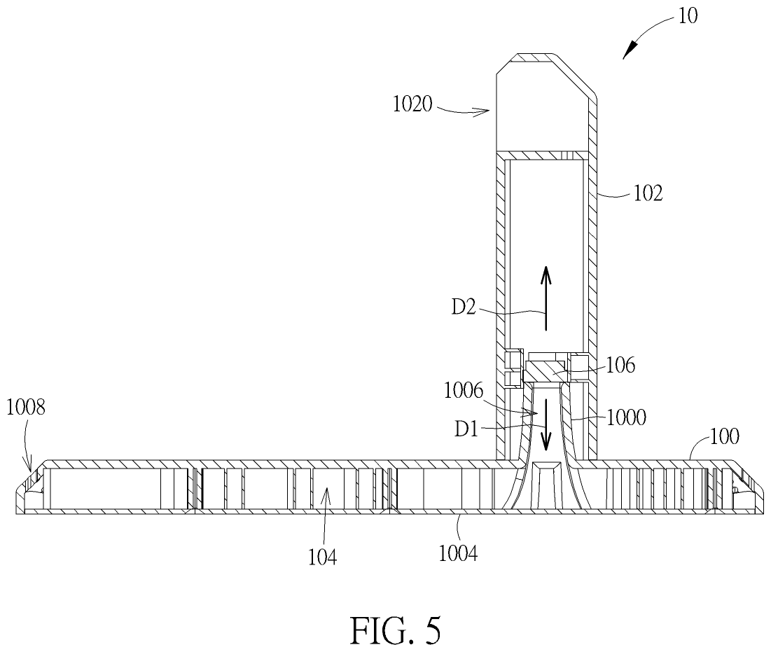

Referring to FIGS. 1 to 5, FIG. 1 is a perspective view illustrating a display device 1 according to an embodiment of the invention, FIG. 2 is an exploded view illustrating the support base 10 shown in FIG. 1 from another viewing angle, FIG. 3 is an exploded view illustrating the support base 10 shown in FIG. 1 from another viewing angle, FIG. 4 is a bottom view illustrating the base body 100 shown in FIG. 3, and FIG. 5 is a sectional view illustrating the support base 10 shown in FIG. 1 along line X-X.

As shown in FIG. 1, the display device 1 comprises a support base 10 and a display unit 12. The support base 10 comprises a base body 100 and a support frame 102, wherein the support frame 102 is disposed on the base body 100. The display unit 12 is disposed on the support frame 102. In practical applications, the display unit 12 may be disposed on the support frame 102 by a hinge. In this embodiment, the display unit 12 may be, but not limited to, a display (e.g. liquid crystal display, plasma display, organic light emitting diode display and so on. In another embodiment, the display unit 12 may also be replaced by other objects disposed on the support frame 102 of the support base 10. In other words, the support base 10 is not limited to cooperate with the display unit 12 to form the display device 1.

In this embodiment, the base body 100 may have an accommodating structure 1000, as shown in FIG. 2. Furthermore, the support base 10 further comprises at least one nonlinear sound passage 104 and a speaker 106. The nonlinear sound passage 104 is disposed in the base body 100 and the speaker 106 is accommodated by the accommodating structure 1000 of the base body 100. In this embodiment, the support base 10 may comprise four nonlinear sound passages 104 and the base body 100 may have four edges 1002, wherein the four nonlinear sound passages 104 are disposed in the base body 100 with respect to the four edges 1002, as shown in FIGS. 3 and 4. It should be noted that the number and position of the nonlinear sound passages 104 may be determined according to practical applications, so the invention is not limited to the embodiment shown in the figures. Still further, the length and width of each nonlinear sound passage 104 may be identical or different according to practical applications. In this embodiment, the base body 100 may have a cover 1004, wherein the cover 1004 is detachably disposed on a bottom of the base body 100 and covers the nonlinear sound passages 104.

In this embodiment, each of the nonlinear sound passages 104 has a sound inlet 1040, a sound outlet 1042 and a passage body 1044, wherein the passage body 1044 is located between the sound inlet 1040 and the sound outlet 1042. As shown in FIGS. 3 and 4, the passage body 1044 may be, but not limited to, S-shaped. In another embodiment, the passage body 1044 may also be designed as other nonlinear shapes according to practical applications. It should be noted that the aforesaid S-shape may consist of straight segment(s) and curved segment(s) or only consist of curved segment(s) according to practical applications. Furthermore, the base body 100 may have a plurality of first sound holes 1008 formed on the four edges 1002 of the base body 100. The sound outlet 1042 of the nonlinear sound passage 104 is disposed with respect to the first sound holes 1008. Moreover, the accommodating structure 1000 of the base body 100 has a hollow chamber 1006, wherein the hollow chamber 1006 communicates with the sound inlet 1040 of the nonlinear sound passage 104. Accordingly, the speaker 106 can output sound to the nonlinear sound passage 104 through the hollow chamber 1006.

As shown in FIG. 5, the speaker 106 may output sound toward the base body 100 in a first direction D1 and the speaker 106 may output sound toward the support frame 102 in a second direction D2, wherein and the first direction D1 is different from the second direction D2. In this embodiment, the first direction D1 is opposite to the second direction D2. For example, the sound outputted by the speaker 106 in the first direction D1 may be, but not limited to, front-side sound wave of the speaker 106 and the sound outputted by the speaker 106 in the second direction D2 may be, but not limited to, back-side sound wave of the speaker 106.

The sound outputted by the speaker 106 in the first direction D1 passes through the hollow chamber 1006 and the sound inlet 1040 of the nonlinear sound passage 104 and then enters the passage body 1044 of the nonlinear sound passage 104. When the sound passes through the passage body 1044 of the nonlinear sound passage 104, the passage body 1044 continuously reflects the sound to reinforce the amplitude of the sound. Accordingly, the invention can enhance sound effect for the speaker 106 effectively. After the sound passes through the passage body 1044 of the nonlinear sound passage 104, the reinforced sound passes through the sound outlet 1042 of the nonlinear sound passage 104 and then is outputted from the first sound holes 1008 of the base body 100.

In this embodiment, a width W1 of the passage body 1044 of the nonlinear sound passage 104 may increase gradually from the sound inlet 1040 to the sound outlet 1042, so as to further reinforce the amplitude of the sound. In another embodiment, the width W1 of the passage body 1044 of the nonlinear sound passage 104 may be constant from the sound inlet 1040 to the sound outlet 1042 and it may also reinforce the amplitude of the sound. Furthermore, a width W2 of the sound outlet 1042 of the nonlinear sound passage 104 may increase gradually toward the first sound holes 1008 to cover all of the first sound holes 1008. Accordingly, the sound outlet 1042 of the nonlinear sound passage 104 may diffuse the sound uniformly to each of the first sound holes 1008, such that the sound outputted from each of the first sound holes 1008 is more harmonious.

In this embodiment, the support frame 102 may have a second sound hole 1020. Thus, the sound outputted by the speaker 106 in the second direction D2 is outputted from the support frame 102 through the second sound hole 1020. Accordingly, the invention may further enhance sound effect for the speaker 106.

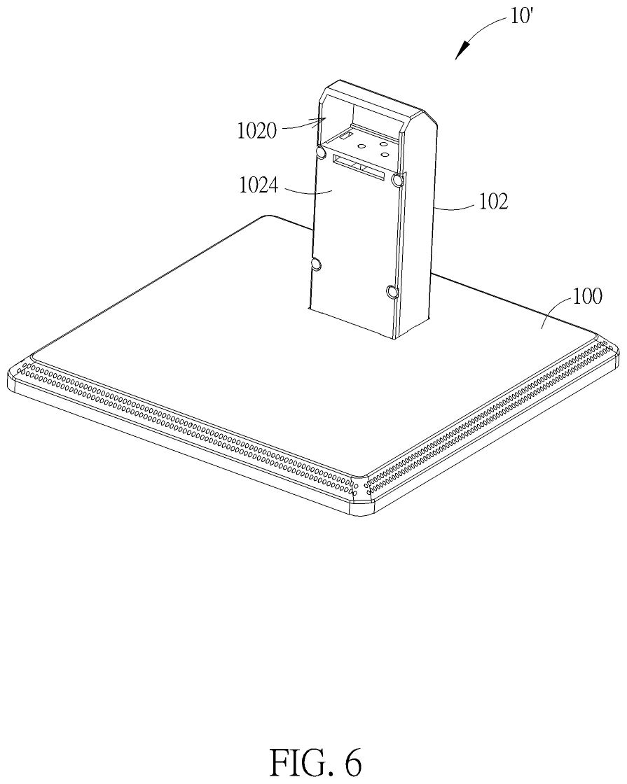

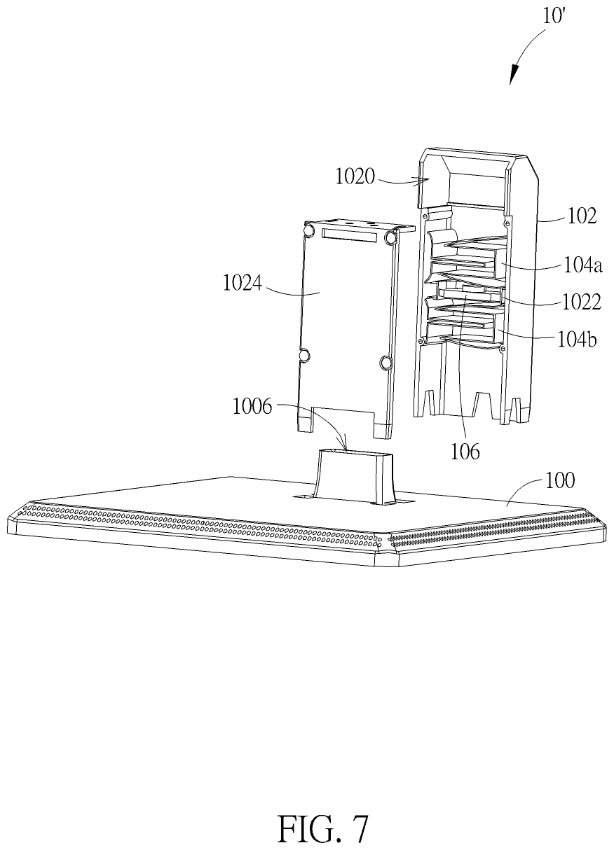

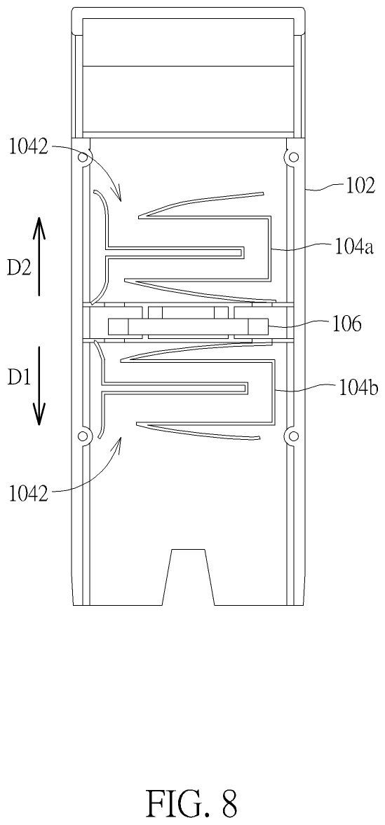

Referring to FIGS. 6 to 8, FIG. 6 is a perspective view illustrating a support base 10′ according to another embodiment of the invention, FIG. 7 is an exploded view illustrating the support base 10′ shown in FIG. 6, and FIG. 8 is a front view illustrating the support frame 102 and the speaker 106 shown in FIG. 7.

The main difference between the support base 10′ and the aforesaid support base 10 is that the nonlinear sound passage of the support base 10′ is disposed in the support frame 102, as shown in FIGS. 7 and 8. In this embodiment, two nonlinear sound passages 104a, 104b may be disposed in the support frame 102, wherein the nonlinear sound passage 104a is located on the first direction D1 and the nonlinear sound passage 104b is located on the second direction D2. Accordingly, the sound outlet 1042 of the nonlinear sound passage 104a is disposed with respect to the second sound hole 1020 of the support frame 102 and the sound outlet 1042 of the nonlinear sound passage 104b is disposed with respect to the hollow chamber 1006 of the base body 100. Furthermore, the support frame 102 has an accommodating structure 1022 and the speaker 106 is accommodated by the accommodating structure 1022. In this embodiment, the support frame 102 may have a cover 1024, wherein the cover 1024 is detachably disposed on a side of the support frame 102 and covers the nonlinear sound passages 104a, 104b and the speaker 106.

The sound outputted by the speaker 106 in the first direction D1 passes through the nonlinear sound passage 104b and the hollow chamber 1006 and then enters the base body 100. It should be noted that the structure of the base body 100 of the support base 10′ may be designed according to the aforesaid embodiment, so the repeated explanation will not be depicted herein again. Needless to say, the base body 100 of the support base 10′ may not comprise the aforesaid nonlinear sound passages 104 according to practical applications. The sound outputted by the speaker 106 in the second direction D2 passes through the nonlinear sound passage 104a and the second sound hole 1020 and then is outputted from the support frame 102. The structure and principle of the nonlinear sound passages 104a, 104b are identical to the structure and principle of the aforesaid nonlinear sound passages 104. Accordingly, when the sound outputted by the speaker 106 passes through the nonlinear sound passages 104a, 104b, the nonlinear sound passages 104a, 104b continuously reflect the sound to reinforce the amplitude of the sound. Accordingly, the invention can enhance sound effect for the speaker 106 effectively.

According to the aforesaid embodiments, the invention may selectively dispose at least one nonlinear sound passage in at least one of the base body and the support frame. Furthermore, at least one of the base body and the support frame of the invention may have an accommodating structure for accommodating the speaker.

As mentioned in the above, the invention disposes the speaker in the support base. Since a casing of the display device does not need to retain a space for accommodating the speaker, the display device can be further thinned. Furthermore, the invention further disposes the nonlinear sound passage in at least one of the base body and the support frame of the support base. When the sound outputted by the speaker passes through the nonlinear sound passage, the nonlinear sound passage continuously reflects the sound to reinforce the amplitude of the sound. Accordingly, the invention can enhance sound effect for the speaker effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A support base comprising:
a base body;
a support frame disposed on the base body, at least one of the base body and the support frame having an accommodating structure;
at least one nonlinear sound passage selectively disposed in at least one of the base body and the support frame; and
a speaker accommodated by the accommodating structure, the speaker outputting sound to the nonlinear sound passage.

2. The support base of claim 1, wherein the nonlinear sound passage has a sound inlet, a sound outlet and a passage body, the passage body is located between the sound inlet and the sound outlet, and a width of the passage body increases gradually from the sound inlet to the sound outlet or is constant.

3. The support base of claim 2, wherein the passage body is S-shaped.

4. The support base of claim 1, wherein the nonlinear sound passage has a sound outlet and a width of the sound outlet increases gradually.

5. The support base of claim 1, wherein the nonlinear sound passage is disposed in the base body, the nonlinear sound passage has a sound outlet, the base body has a first sound hole, and the sound outlet is disposed with respect to the first sound hole.

6. The support base of claim 1, wherein the nonlinear sound passage is disposed in the support frame, the nonlinear sound passage has a sound outlet, the support frame has a second sound hole, and the sound outlet is disposed with respect to the first sound hole.

7. The support base of claim 1, comprising four nonlinear sound passages, the base body having four edges, the four nonlinear sound passages being disposed in the base body with respect to the four edges.

8. The support base of claim 1, wherein the speaker outputs sound toward the base body in a first direction, the speaker outputs sound toward the support frame in a second direction, and the first direction is different from the second direction.

9. A display device comprising:
a support base comprising:
a base body;
a support frame disposed on the base body, at least one of the base body and the support frame having an accommodating structure;
at least one nonlinear sound passage selectively disposed in at least one of the base body and the support frame; and
a speaker accommodated by the accommodating structure, the speaker outputting sound to the nonlinear sound passage; and
a display unit disposed on the support frame.

10. The display device of claim 9, wherein the nonlinear sound passage has a sound inlet, a sound outlet and a passage body, the passage body is located between the sound inlet and the sound outlet, and a width of the passage body increases gradually from the sound inlet to the sound outlet or is constant.

11. The display device of claim 10, wherein the passage body is S-shaped.

12. The display device of claim 9, wherein the nonlinear sound passage has a sound outlet and a width of the sound outlet increases gradually.

13. The display device of claim 9, wherein the nonlinear sound passage is disposed in the base body, the nonlinear sound passage has a sound outlet, the base body has a first sound hole, and the sound outlet is disposed with respect to the first sound hole.

14. The display device of claim 9, wherein the nonlinear sound passage is disposed in the support frame, the nonlinear sound passage has a sound outlet, the support frame has a second sound hole, and the sound outlet is disposed with respect to the first sound hole.

15. The display device of claim 9, wherein the support base comprises four nonlinear sound passages, the base body has four edges, and the four nonlinear sound passages are disposed in the base body with respect to the four edges.

16. The display device of claim 9, wherein the speaker outputs sound toward the base body in a first direction, the speaker outputs sound toward the support frame in a second direction, and the first direction is different from the second direction.
